(19) United States
(12) Patent Application Publication
(10) Pub. No.: US 2020/0077672 A1
(43) Pub. Date: Mar. 12, 2020

(54) Pellets for coffee drinks

(71) Applicants: Martin Luke Shih, Brossard (CA); Jeanne Louise Shih, Brossard (CA); Andy Shih, Brossard (CA)

(72) Inventors: Martin Luke Shih, Brossard (CA); Jeanne Louise Shih, Brossard (CA); Andy Shih, Brossard (CA)

(21) Appl. No.: 16/125,720

(22) Filed: Sep. 9, 2018

(51) Int. Cl. A23F 5/12; A23F 5/38; A23F 5/46

(52) U.S. Cl. CPC A23F 5/125; A23F 5/465; A23F 5/385

(57) ABSTRACT

This invention provides pellets for a coffee drink comprising composition components selected from a group of coffee flavours, foam forming materials, binders, flavour enhancement materials, sugars and sweeteners. Ratio or composition and date of manufacturing of the pellets are impressed on each pellet for identification.

### OBJECTIVES OF THE INVENTION

One object of this invention is to provide pellets for a coffee drink comprising a first flavour composition component with a first flavour composition component ratio, a second foam forming composition component with a second foam forming composition component ratio, a third binder composition component with a third binder composition component ratio.

The other object of this invention is to provide pellets for a coffee drink comprising a first flavour composition component with a first flavour composition component ratio, a second foam forming composition component with a second foam forming composition component ratio, a third binder composition component with a third binder composition component ratio, a fourth flavour enhancement composition component with a fourth flavour enhancement composition component ratio.

Still the other object of this invention is to provide pellets for a coffee drink comprising a first flavour composition component with a first flavour composition component ratio, a second foam forming composition component with a second foam forming composition component ratio, a third binder composition component with a third binder composition component ratio, a fourth flavour enhancement composition component with a fourth flavour enhancement composition component ratio, a fifth sweetening composition component with a fifth sweetening composition component ratio.

Yet another object of this invention is to provide pellets for a coffee drink, wherein whole or a part of composition component ratios are imprinted on said pellets.

Another object of this invention is to provide pellets for a coffee drink wherein whole or part date of manufacturing of said pellets is imprinted on said pellets.

Yet another object of this invention is to provide pellets for a coffee drink, wherein whole or parts of composition component ratios and date of manufacturing of said pellets are imprinted on said pellets.

Yet another object of this invention is to provide pellets for a coffee drink, wherein whole or parts of composition component ratios, ingredient weight, daily ingredient percentage intake, date of manufacturing of said pellets and the provenance and conditions along the supply chain (location and time of harvest, location and time of roasting, location and time of manufacturing, location and time of import, location and time of export, location and time of distribution at retail locations, who the harvesters are, who the roasters are, who the manufacturers are, who the importers and exporters are and who the retailers are, etc) of the coffee are imprinted on said pellets.

Still another object of this invention is to provide pellets for a coffee drink, having at least a height with a first cross-section taken perpendicular to the direction of said height, at least a thickness with a second cross-section taken perpendicular to the direction of said thickness and at least a width with a third cross-section taken perpendicular to the direction of said width, wherein shape of said first cross-section is selected from a group including: a square, rectangular, triangle, pentagon, hexagon, octagon, circle, oval, star etc.

### BACKGROUND OF THE INVENTION

Conventional coffee drinks are made using a coffee flavour, a foam forming material, a flavour enhancement material and a sweetening material in powder or in packets. To make the conventional coffee drinks, ratios of the above materials must be controlled each time. In addition, the manufacturing date can be provided only on the containers for these materials. The present invention provides pellets for easy making of coffee drinks. The present invention also provides pellets for easy making of coffee drinks with imprinted information of provenance.

### BRIEF DESCRIPTION OF THE FIGURES

Embodiments of the disclosure will be described by way of example with reference to the accompanying drawings, in which:

FIG. 1: A schematic diagram showing a pellet (100) for making a portion of a coffee drink having a height H1 with a height direction DH, a thickness T1 with a thickness direction DT, a width W1 with a width direction DW. A first cross-section CR1 is taken perpendicular to said height direction DH, a second cross-section CR2 is taken perpendicular to said thickness direction DT, and a third cross-section CR3 is taken perpendicular to said width direction DW. Said first cross-section is a square and said second cross-section is a rectangle.

FIG. 2: A schematic diagram showing a pellet (200) for making a portion of a coffee drink having a top face (200T), bottom face (200Bo), a left face (200L), a right face (200R), a front face (200F) and a back face (200Ba). With a first pattern (170T) imprinted on the top face (200T) and a second pattern (170B) imprinted on bottom face (200Bo) to indicate whole of parts of the date of manufacturing of said pellet, a third pattern (180T) is imprinted on said top face and a fourth pattern is imprinted on said bottom face to indicate whole of parts of ratio of composition components in said pellet.

FIG. 3: A schematic diagram showing a pellet (300) for making a portion of a coffee drink having a height H1 with a height direction DH, a thickness T1 with a thickness direction DT, a width W1 with a width direction DW. A first cross-section CR1 is taken perpendicular to said height direction DH, a second cross-section CR2 is taken perpendicular to said thickness direction DT, and a third cross-section CR3 is taken perpendicular to said width direction DW. Said first cross-section CR1 is an oval whereas second cross-section CR2 is a rectangle.

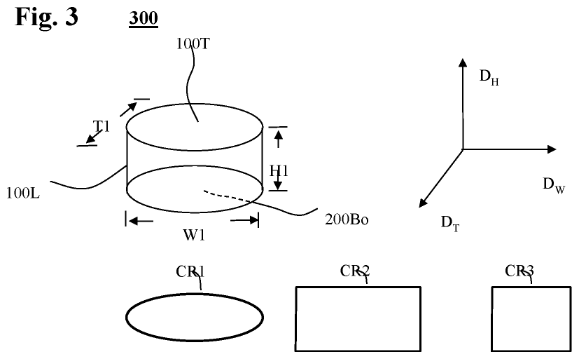

Similar references used in different Figures denote similar components.

### DETAILED DESCRIPTION

The invention provides coffee drinks in the form of pressurized capsules or pellets such that the ingredients that go into a coffee drink are measured and are consistent from one serving to the next. The size and weight of the pellets may equate to single servings of coffee or may be for larger groups where up to four or six servings may be prepared with a single pellet. The range in weight of the pellet may be anywhere from 0.5 mg to 80 grams in one embodiment according to the type of coffee contained in the pellet and the number of servings that may be prepared with a single pellet. For example, one serving of instant coffee is typically 0.07 ounces which is 1.98 grams. A double espresso is approximately 13 grams whereas a single shot is 6.5 grams. For four cups of coffee from a French Press maker, it is recommended that 27 grams of coffee be used. The pellets may contain any enhancement ingredients such as sugar, powdered creamers, binders and powdered flavors. The weight of a 1 cubic centimeter sugar cube is approximately 4 grams. For four cups of coffee, up to 8 cubes of sugar (two cubes per serving) may be considered and would therefore weigh 32 grams. Assuming a pellet may contain 5 types of ingredients including the coffee and up to 4 servings, the maximum weight of a pellet is approximated to be 80 grams. The pellets may be formed in any shape such as cylinders, cubes, spheres, etc. These may be formed also to fit into particular coffee making instruments such as espresso holders and therefore the shapes may be standardized to a particular coffee or espresso machine. The shape may also be for ease of distribution and handling or simply for adherent to marketing purposes.

The approximate minimum dimensional size of a single pellet may be in a range of 1 cm in height, 1 cm in thickness and 1 cm in width. The approximate maximum dimensional size may be up to 10 cm in height, 10 cm in thickness and 10 cm in width for a single pellet. The minimum dimensional size is such that a plurality of pellets may be incorporated into a single drink. The maximum dimensional size is such that a single pellet may be incorporated to prepare several servings or cups of drinks.

The pellets allow for a drinker to easily enjoy a consistent coffee drink that contains the same amount of ingredients every time. The pellets may be made of pressurized or bound capsules of powdered instant coffee or espresso grains that may be prepared by any means, including but not restricted to the dissolving of the pellets in hot water in a cup, in a French press or the preparation of coffee using a stovetop espresso maker or any coffee maker. The pellets allow for a measured amount of ingredients to be consistent from serving to serving and for the preparation to be performed with a one-shot action, eliminating the need for digging into coffee grains, digging into sugar and digging into creamers and putting inconsistent amounts in the coffee. The ease with which a coffee may be prepared and enjoyed is improved and sped up. In one embodiment, the pellets may be administered to the water by hand, in another embodiment the pellets may be administered by a machine.

With the hard surface of the pellets, in one embodiment, information about the ingredients and the preparation of the ingredients along the supply chain may be imprinted onto the pellets using edible ink. Each pellet may be imprinted with any of the following information: ingredient weight, daily ingredient percentage intake, whole or parts of composition component ratios, date of manufacturing of said pellets and the provenance and conditions of processing and handling along the supply chain, location and time of harvest, location and time of roasting, location and time of manufacturing, location and time of import, location and time of export, location and time of distribution, who the harvesters are, who the roasters are, who the manufacturers are, who the importers and exporters are and who the retailers are, time and date of processing and handling, etc. Branding may also be imprinted on each pellet.

Binders to bind the pellet grains and powders together may be incorporated. Binder Categories include the following: sucrose, liquid glucose, acacia, tragacanth, gelatin, starch paste, pregelatinized starch, alginic acid, cellulose, methyl cellulose, ethyl cellulose, hydroxy propyl methyl cellulose (HPMC), hydroxy propyl cellulose, sodium carobxy methyl cellulose, polyvinyl pyrrplidone (PVP), polethylene glycol (PEG), polyvinyl alcohols, polymetharcrylates. Typical binders used to bond the pellets together may be Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab.

Powdered creamers such as different types of milks and creams may be incorporated into the pellet. These may be from a group of ingredients including powdered creamer mix, powdered dairy milk or cream, powdered oat milk, powdered almond milk, powdered soy milk, powdered macadamia milk, powdered coconut milk, powdered rice milk, powdered cashew milk, powdered hemp milk. These may be either whole, reduced, skimmed, organic, etc.

Flavors, nutritional enhancements or recreational enhancements in the form of powder, extracts or oils may also be incorporated in the pellets for enhancement of the coffee drink. These may be, but are not restricted to flavors from Cocoa, chai, chicory, tea, maple syrup, fruit, apple, blackberry, berry, blueberry, strawberry, acai, chamomile, chocolate, salted caramel, mango, cranberry, ginger, hibiscus, lemongrass, orange, green tea, pumpkin, peach, raspberry, rose hips, apple cider, lemon, lime, earl grey, turmeric, vanilla, almond, peppermint, cardamon, ceylon, superfruit, reishi, superherb, herb, elderberry, pomegranate, jasmine, pineapple, elderflower, cucumber, mint, matcha, saffron, saffron rose, red tea, green tea, oolong tea, pu-erh tea, white tea, herbal tea, rooibos tea, yerba mate, black tea, sage, rose petal, banana, goji berry, ginseng, vanilla bean, honey, baobab, spice mix, plum, apricot, amaretto, black current, black cherry, cherry, darjeeling, lemongrass, lavender, passion fruit, marmalade, orange pekoe, orchid, rum, marshmallow, ambrosia, pink salt, red wine, cayenne pepper, cane sugar, brandy, hemp, edible marijuana, edible cannabis, edible oil, sativa, indica, guarana seed extract, Echinacea flower extract, ginseng root extract, taurine, vitamins, caffeine, minerals, Hops, Potassium, Chamomile, L-Theanine.

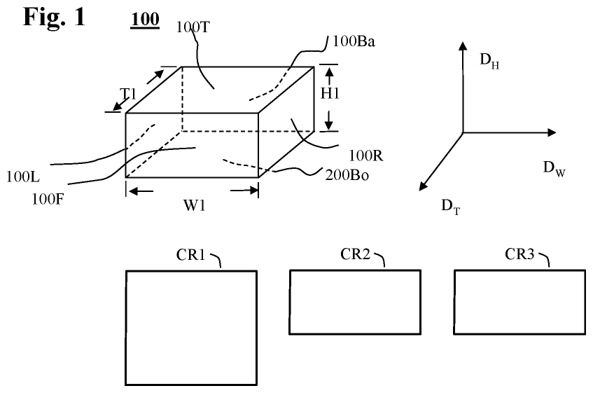

According to one embodiment of this invention, a pellet (100 see FIG. 1) for making a portion of a serving of coffee drink having a height H1, a thickness T1, a width W1, a first cross-section CR1 taken perpendicular to the height direction DH, a second cross-section CR2 taken perpendicular to the thickness direction DT, and a third cross-section CR3 taken perpendicular to the width direction DW, a top face (110) and a bottom face (120), comprising a first composition component with a first composition component weight ratio C1, a second composition component with a second composition component weight ratio C2 and a third composition component with a third composition component weight ratio C3, said first composition component is selected from a group including: Coffee, Espresso, americano, latte, macchiato, cappuccino, mocha, caramel macchiato, cortado, french vanilla, vanilla caramel, hazelnut, java, caramel, cinnamon, vanilla, white chocolate, coconut, peppermint, mint, decaffeinated, sweet, unsweetened, creamy, rich, bold, classic, smooth, medium, full, well-balanced, light, mild, house blend, mountain blend, family blend, natural, Italian blend/roast, Colombian, International blend/roast, American blend/roast, French blend/roast, Vietnamese blend/roast, Chinese blend/roast, Korean blend/roast, African blend/roast, Moroccan blend/roast, mushroom, hemp, organic, freeze dried, said second composition component is selected from a group of foam forming materials including: powdered creamer mix, powdered dairy milk or cream, powdered oat milk, powdered almond milk, powdered soy milk, powdered macadamia milk, powdered coconut milk, powdered rice milk, powdered cashew milk, powdered hemp milk. (whole, reduced, skimmed, organic), and said third composition component is selected from a group of binder materials including: Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab etc. Said third composition component is selected from a group: Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab.

According to the other embodiment of this invention, said first composition component weight ratio C1 is selected to be in a range 0.2<C1<0.9 whereas said second component weight ratio C2 is selected in a range 0.1<C2<0.8, whereas 0.1<C3<0.2.

According to yet the other embodiment of this invention, a pellet for making a portion of a coffee drink, said height of the pellet is selected to be H1<10 cm and more preferably H1<2 cm, said thickness is selected to be T1<10 cm and more preferably T1<2 cm and said width is selected to be W1<10 cm.

According to still the other embodiment of this invention, a pellet for making a portion of a serving of coffee, further comprising a fourth composition component with a fourth composition component weight ratio C4 for enhancing flavours of said coffee drink. Wherein said fourth composition component weight ratio is 0.01<C4<0.2. Said fourth composition component is selected from a group: Cocoa, chai, chicory, tea, maple syrup, fruit, apple, blackberry, berry, blueberry, strawberry, acai, chamomile, chocolate, salted caramel, mango, cranberry, ginger, hibiscus, lemongrass, orange, green tea, pumpkin, peach, raspberry, rose hips, apple cider, lemon, lime, earl grey, turmeric, vanilla, almond, peppermint, cardamon, ceylon, superfruit, reishi, superherb, herb, elderberry, pomegranate, jasmine, pineapple, elderflower, cucumber, mint, matcha, saffron, saffron rose, red tea, green tea, oolong tea, pu-erh tea, white tea, herbal tea, rooibos tea, yerba mate, black tea, sage, rose petal, banana, goji berry, ginseng, vanilla bean, honey, baobab, spice mix, plum, apricot, amaretto, black current, black cherry, cherry, darjeeling, lemongrass, lavender, passion fruit, marmalade, orange pekoe, orchid, rum, marshmallow, ambrosia, pink salt, red wine, cayenne pepper, cane sugar, brandy, hemp, edible marijuana, edible cannabis, edible oil, sativa, indica, guarana seed extract, Echinacea flower extract, ginseng root extract, taurine, vitamins, caffeine, minerals, Hops, Potassium, Chamomile, L-Theanine.

According to another embodiment of this invention, a pellet for making a portion of a serving of coffee drink, further comprising a fifth composition component with a fifth composition component weight ratio C5 for sweetening of said coffee drink. Wherein said fifth composition component weight ratio is 0.1<C5<0.7. Said fifth composition component is selected from a group: Sugar in various forms: white sugar, brown sugar, raw sugar, turbinado sugar, honey, stevia and a group of artificial low-calorie sweeteners include: saccharin, aspartame, acesulfame, potassium or ace-K, sucralose, advantame, neotame.

According to yet another embodiment of this invention, a pellet for making a portion of a serving of a coffee drink, wherein said second cross-section is selected from a group including a square and a rectangle. As shown in FIG. 1, the thickness direction DT is along the thickness T1 of said pellet (100). The second cross-section CR2 is a rectangle for the pellet in FIG. 1. The second cross-section may be a square, a pentagon or other shapes. The exact shape of said second cross-section is determined by the shape of moulds used to form the pellets.

According to a further embodiment of this invention, a pellet for making a portion of a serving of a coffee drink, wherein shape of said first cross-section is selected from a group including: a square, rectangle, triangle, pentagon, hexagon, octagon, circle, oval, star, and etc. As shown in FIG. 1, the height direction DH is along the height H1 of said pellet (100). Said first cross-section is a square in FIG. 1. The shape of said first cross-section may also be a square rectangle, triangle, pentagon, hexagon, octagon, circle, oval, star, and etc. The exact shape of said first cross-section is determined by the shape of moulds used to form the pellets.

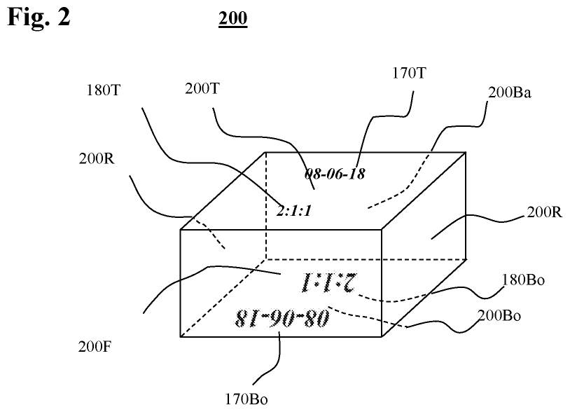

According the other embodiment of this invention, a pellet (200) for making a portion of a serving of a coffee drink as shown in FIG. 2, which has a top face (200T), a bottom face (200Bo), a front face (200F), a back face (200Ba), a left face (200L) and a right face (200R), wherein a third pattern (180T) is imprinted on said top face (200T) and a fourth pattern (180B) is imprinted on bottom face (200B) to indicate a ratio between said first composition component weight ratio, second composition component weight ratio, third composition component weight ratio and fifth composition component weight ratio. To simplify the imprinting, said third pattern and fourth pattern may contain only ratio second composition component (foam forming component) and fifth composition component (sweetening composition component).

According to yet the other embodiment of this invention, a pellet for making a portion of a coffee drink as shown in FIG. 2, which has a top face (200T), a bottom face (200Bo), a front face (200F), a back face (200Ba), a left face (200L) and a right face (200R), wherein a first pattern (170T) is imprinted on said top face (200T) and a second pattern (170B) is imprinted on bottom face (200B) to indicate a date of manufacturing of said pellet. To simplify the imprinting, the first pattern and second pattern may contain only the month and year of manufacturing. To simplify further the first pattern and second pattern, they may contain only the year of manufacturing.

According to still the other embodiment of this invention, a pellet for making a portion of a coffee drink, further comprising a pattern imprinted on said top face and bottom face to indicate flavour of said pellet.

Still another embodiment, a pellet for making a portion of a coffee drink wherein a single pellet is for one serving, or two pellets for one serving, or four pellets for one serving or a multiple pellets for a serving.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope and spirit of the disclosure as hereinafter claimed.

What is claimed:

1. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, comprising a first composition component with a first composition component weight ratio C1, and a second composition component with a second composition component weight ratio C2, said first composition component is selected from a group including: Coffee, Espresso, americano, latte, macchiato, cappuccino, mocha, caramel macchiato, cortado, french vanilla, vanilla caramel, hazelnut, java, caramel, cinnamon, vanilla, white chocolate, coconut, peppermint, mint, decaffeinated, sweet, unsweetened, creamy, rich, bold, classic, smooth, medium, full, well-balanced, light, mild, house blend, mountain blend, family blend, natural, Italian blend/roast, Colombian, International blend/roast, American blend/roast, French blend/roast, Vietnamese blend/roast, Chinese blend/roast, Korean blend/roast, African blend/roast, moroccan blend/roast, mushroom, hemp, organic, freeze dried, and said second composition component is selected from a group of foam forming materials including: powdered creamer mix, powdered dairy milk or cream, powdered oat milk, powdered almond milk, powdered soy milk, powdered macadamia milk, powdered coconut milk, powdered rice milk, powdered cashew milk, powdered hemp milk. (whole, reduced, skimmed, organic)

2. A pellet for making a portion of a serving of coffee drink having a height H1, a thickness T1, a width W1, a first cross-section taken perpendicular to direction of said height, a second cross-section taken perpendicular to direction of said thickness, and a third cross-section taken perpendicular to direction of said width, a top face and a bottom face in claim 1, said first composition component weight ratio C1 is selected to be in a range 0.2<C1<0.9 whereas said second component weight ratio C2 is selected in a range 0.1<C2<0.8.

3. A pellet for making a portion of a serving of coffee drink having a height H1, a thickness T1, a width W1, a first cross-section taken perpendicular to direction of said height, a second cross-section taken perpendicular to the direction of said thickness, and a third cross-section taken perpendicular to direction of said width, a top face and a bottom face in claim 1, where said height is selected to be H1<10 cm, said thickness is selected to be T1<10 cm and said width is selected to be W1<10 cm.

4. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 1, further comprising a third composition component with a third composition component weight ratio C3 for enhancing the binding of said pellet. Said third composition component is selected from a group of binder materials including: Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab etc. Said third composition component is selected from a group: Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab.

5. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 1, further comprising a fourth composition component with a fourth composition component weight ratio C4 for enhancing flavours of said coffee drink. Said fourth composition component is selected from a group: Cocoa, Chai, Chicory, Tea, Maple syrup, fruit, apple, blackberry, berry, blueberry, strawberry, acai, chamomile, chocolate, salted caramel, mango, cranberry, ginger, hibiscus, lemongrass, orange, green tea, pumpkin, peach, raspberry, rose hips, apple cider, lemon, lime, earl grey, turmeric, vanilla, almond, peppermint, cardamon, ceylon, superfruit, reishi, superherb, herb, elderberry, pomegranate, jasmine, pineapple, elderflower, cucumber, mint, matcha, saffron, saffron rose, red tea, green tea, oolong tea, pu-erh tea, white tea, herbal tea, rooibos tea, yerba mate, black tea, sage, rose petal, banana, goji berry, ginseng, vanilla bean, honey, baobab, spice mix, plum, apricot, amaretto, black current, black cherry, cherry, darjeeling, lemongrass, lavender, passion fruit, marmalade, orange pekoe, orchid, rum, marshmallow, ambrosia, pink salt, red wine, cayenne pepper, cane sugar, brandy, hemp, edible marijuana, edible cannabis, edible oil, sativa, indica.

6. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 1, further comprising a fifth composition component with a fifth composition component weight ratio C5 for sweetening of said coffee drink. Said fifth composition component is selected from a group. Said fifth composition component is selected from a group: Sugar in various forms: white sugar, brown sugar, raw sugar, turbinado sugar, honey, stevia and a group of artificial low-calorie sweeteners include: saccharin, aspartame, acesulfame, otassium or ace-K, sucralose, advantame, neotame

7. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 1, wherein shape of said second cross-section is selected from a group including: a square and a rectangle.

8. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, in claim 1, wherein shape of said first cross-section is selected from a group including: a square, rectangle, triangle, pentagon, hexagon, octagon, circle, oval, star, and etc.

9. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, in claim 1, further comprising a pattern imprinted on said top face and bottom face to indicate said second composition component weight ratio.

10. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, in claim 1, further comprising a pattern imprinted on said top face and bottom face to indicate date of manufacturing of said pellet.

11. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 1, further comprising a pattern imprinted on said top face and bottom face to indicate flavour of said pellet.

12. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, comprising a first composition component with a first composition component weight ratio C1, a second composition component with a second composition component weight ratio C2 and a third composition component with a third composition component weight ratio C3, said first composition component is selected from a group including: Coffee, Espresso, americano, latte, macchiato, cappuccino, mocha, caramel macchiato, cortado, french vanilla, vanilla caramel, hazelnut, java, caramel, cinnamon, vanilla, white chocolate, coconut, peppermint, mint, decaffeinated, sweet, unsweetened, creamy, rich, bold, classic, smooth, medium, full, well-balanced, light, mild, house blend, mountain blend, family blend, natural, Italian blend/roast, Colombian, International blend/roast, American blend/roast, French blend/roast, Vietnamese blend/roast, Chinese blend/roast, Korean blend/roast, African blend/roast, moroccan blend/roast, mushroom, hemp, organic, freeze dried, said second composition component is selected from a group of foam forming materials including: powdered creamer mix, powdered dairy milk or cream, powdered oat milk, powdered almond milk, powdered soy milk, powdered macadamia milk, powdered coconut milk, powdered rice milk, powdered cashew milk, powdered hemp milk. (whole, reduced, skimmed, organic), and said third composition component is selected from a group of binder materials including: Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab etc. Said third composition component is selected from a group: Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab.

13. A pellet for making a portion of a serving of coffee drink having a height H1, a thickness T1, a width W1, a first cross-section taken perpendicular to direction of said height, a second cross-section taken perpendicular to direction of said thickness, and a third cross-section taken perpendicular to direction of said width, a top face and a bottom face in claim 12, said first composition component weight ratio C1 is selected to be in a range 0.2<C1<0.9 whereas said second component weight ratio C2 is selected in a range 0.1<C2<0.8, whereas 0.1<C3<0.2.

14. A pellet for making a portion of a serving of coffee drink having a height H1, a thickness T1, a width W1, a first cross-section taken perpendicular to direction of said height, a second cross-section taken perpendicular to the direction of said thickness, and a third cross-section taken perpendicular to direction of said width, a top face and a bottom face in claim 12, where said height is selected to be H1<10 cm, said thickness is selected to be T1<10 cm and said width is selected to be W1<10 cm.

15. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 12, further comprising a fourth composition component with a fourth composition component weight ratio C4 for enhancing flavours of said coffee drink. Said fourth composition component is selected from a group: Cocoa, Chai, Chicory, Tea, Maple syrup, fruit, apple, blackberry, berry, blueberry, strawberry, acai, chamomile, chocolate, salted caramel, mango, cranberry, ginger, hibiscus, lemongrass, orange, green tea, pumpkin, peach, raspberry, rose hips, apple cider, lemon, lime, earl grey, turmeric, vanilla, almond, peppermint, cardamon, ceylon, superfruit, reishi, superherb, herb, elderberry, pomegranate, jasmine, pineapple, elderflower, cucumber, mint, matcha, saffron, saffron rose, red tea, green tea, oolong tea, pu-erh tea, white tea, herbal tea, rooibos tea, yerba mate, black tea, sage, rose petal, banana, goji berry, ginseng, vanilla bean, honey, baobab, spice mix, plum, apricot, amaretto, black current, black cherry, cherry, darjeeling, lemongrass, lavender, passion fruit, marmalade, orange pekoe, orchid, rum, marshmallow, ambrosia, pink salt, red wine, cayenne pepper, cane sugar, brandy, hemp, edible marijuana, edible cannabis, edible oil, sativa, indica.

16. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 12, further comprising a fifth composition component with a fifth composition component weight ratio C5 for sweetening of said coffee drink. Said fifth composition component is selected from a group: Sugar in various forms: white sugar, brown sugar, raw sugar, turbinado sugar, honey, stevia and a group of artificial low-calorie sweeteners include: saccharin, aspartame, acesulfame, otassium or ace-K, sucralose, advantame, neotame

17. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 12, wherein shape of said second cross-section is selected from a group including: a square and a rectangle.

18. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, in claim 12, wherein shape of said first cross-section is selected from a group including: a square, rectangle, triangle, pentagon, hexagon, octagon, circle, oval, star, and etc.

19. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, in claim 12, further comprising a pattern imprinted on said top face and bottom face to indicate said second composition component weight ratio.

20. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, in claim 12, further comprising a pattern imprinted on said top face and bottom face to indicate date of manufacturing of said pellet.

21. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face in claim 12, further comprising a pattern imprinted on said top face and bottom face to indicate flavour of said pellet.

22. A pellet for making a portion of a serving of coffee drink having a height H1, a thickness T1, a width W1, a first cross-section taken perpendicular to the direction of said height, a second cross-section taken perpendicular to the direction of said thickness, and a third cross-section taken perpendicular to the direction of said width, a top face and a bottom face, comprising a first composition component with a first composition component weight ratio C1, a second composition component with a second composition component weight ratio C2 and a third composition component with a third composition component weight ratio C3, a fourth composition component with a fourth composition component weight ratio C4, and a fifth composition component with a fifth composition component weight ratio C5, said first composition component is selected from a group including: Coffee, Espresso, americano, latte, macchiato, cappuccino, mocha, caramel macchiato, cortado, french vanilla, vanilla caramel, hazelnut, java, caramel, cinnamon, vanilla, white chocolate, coconut, peppermint, mint, decaffeinated, sweet, unsweetened, creamy, rich, bold, classic, smooth, medium, full, well-balanced, light, mild, house blend, mountain blend, family blend, natural, Italian blend/roast, Colombian, International blend/roast, American blend/roast, French blend/roast, Vietnamese blend/roast, Chinese blend/roast, Korean blend/roast, African blend/roast, moroccan blend/roast, mushroom, hemp, organic, freeze dried, said second composition component is selected from a group of foam forming materials including: powdered creamer mix, powdered dairy milk or cream, powdered oat milk, powdered almond milk, powdered soy milk, powdered macadamia milk, powdered coconut milk, powdered rice milk, powdered cashew milk, powdered hemp milk. (whole, reduced, skimmed, organic), and said third composition component is selected from a group of binder materials including: Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab etc. Said third composition component is selected from a group: Starch 1500, Methocel, Walocel HM, Luvitec, Luvicross, Luvicaproclactam, starch paste, pregelatinized starch (PGS), Direct compression binders: Avicel, SMCC, Uni-Pure, DC Lactose, DI Tab, said fourth composition component is for flavour enhancement and is selected from a group: Cocoa, chai, chicory, tea, maple syrup, fruit, apple, blackberry, berry, blueberry, strawberry, acai, chamomile, chocolate, salted caramel, mango, cranberry, ginger, hibiscus, lemongrass, orange, green tea, pumpkin, peach, raspberry, rose hips, apple cider, lemon, lime, earl grey, turmeric, vanilla, almond, peppermint, cardamon, ceylon, superfruit, reishi, superherb, herb, elderberry, pomegranate, jasmine, pineapple, elderflower, cucumber, mint, matcha, saffron, saffron rose, red tea, green tea, oolong tea, pu-erh tea, white tea, herbal tea, rooibos tea, yerba mate, black tea, sage, rose petal, banana, goji berry, ginseng, vanilla bean, honey, baobab, spice mix, plum, apricot, amaretto, black current, black cherry, cherry, darjeeling, lemongrass, lavender, passion fruit, marmalade, orange pekoe, orchid, rum, marshmallow, ambrosia, pink salt, red wine, cayenne pepper, cane sugar, brandy, hemp, edible marijuana, edible cannabis, edible oil, sativa, indica, whereas said fifth composition component is for sweetening and is selected from a group of: Sugar in various forms including white sugar, brown sugar, raw sugar, turbinado sugar, honey, stevia and artificial low-calorie sweeteners including saccharin, aspartame, acesulfame potassium or ace-K, sucralose, advantame and neotame.
